(19) United States
(12) Patent Application Publication
(10) Pub. No.: US 2011/0065890 A1
(43) Pub. Date: Mar. 17, 2011

(54) CALCIUM PHOSPHATE/BIODEGRADABLE POLYMER HYBRID MATERIAL, METHOD FOR PRODUCING SAME AND IMPLANT USING THE HYBRID MATERIAL

(75) Inventors: Mamoru Aizawa, Kawasaki-shi (JP); Yusuke Shigemitsu, Kawasaki-shi (JP); Masashi Makita, Toyohashi-shi (JP)

(73) Assignees: MEIJI UNIVERSITY, Tokyo (JP); SHOWA IKA KOHGYO, LTD., Toyohashi-shi (JP)

(21) Appl. No.: 12/881,909

(22) Filed: Sep. 14, 2010

Related U.S. Application Data
(60) Provisional application No. 61/242,261, filed on Sep. 14, 2009.

(30) Foreign Application Priority Data
Mar. 16, 2010 (JP) 2010-059218

(51) Int. Cl. C08G 63/692; C08G 63/06

(52) U.S. Cl. 528/287; 528/361

(57) ABSTRACT

The present invention provides a calcium phosphate/biodegradable polymer hybrid material with high strength prepared by complexing a calcium phosphate porous material and a biodegradable polymer having a average molecular weight of 50,000 to 500,000, an implant comprising the hybrid material, and a method for producing a calcium phosphate/biodegradable polymer hybrid material prepared by immersing the calcium phosphate porous material within a solution including a biodegradable polymer and performing an ultrasonic treatment or a suction treatment.

### BACKGROUND OF THE INVENTION

1. Field of the Invention

The present invention relates to a calcium phosphate/biodegradable polymer hybrid material, a method for producing such a hybrid material and an implant that uses the hybrid material, and relates more specifically to a hybrid material that is ideal for the repair or replacement of the hard tissue of bones.

Priority is claimed on Japanese Patent Application No. 2010-059218, filed Mar. 16, 2010, the content of which is incorporated herein by reference.

2. Description of the Related Art

Damage to hard tissue such as bone requires that a material be used to repair that hard tissue damage. That material is often required to exhibit sufficient mechanical strength to enable the function of the damaged hard tissue to be maintained. These materials are used either as temporary materials while the hard tissue repairs itself, or as permanent replacements for the hard tissue. Ceramics are one example of the types of materials used for the repair of hard tissues.

In recent years, three types of ceramics have been used clinically for the purposes described above. The first type of ceramic is a biologically active ceramic that bonds directly to the bone of the patient. Examples of this type of ceramic include materials such as hydroxyapatite (HAp: Ca₁₀(PO₄)₆(OH)₂). The second type of ceramic is a bioabsorbable ceramic that is gradually absorbed by the body. Examples of this type of ceramic include materials such as β-tricalcium phosphate (β-TCP: Ca₃(PO₄)₂). The third type of ceramic is a ceramic that is inactive in vivo, but exhibits a high degree of mechanical strength. Examples of this type of ceramic include α-alumina (α-Al₂O₃) and tetragonal zirconia (t-ZrO₂).

Hydroxyapatite as the first type of ceramic, has a chemical structure similar to that of naturally-occurring structural components that exist within the teeth and bones of humans. Accordingly, hydroxyapatite exhibits excellent biocompatibility, and is therefore an ideal candidate for a material for the replacement or repair of damaged hard tissue. Indeed, hydroxyapatite is already in use as a material for replacing or repairing damaged bones, and as a coating material for promoting the growth of bone on implants. Medical implants such as artificial hip joints and dental implants are typically coated with hydroxyapatite, and it has been confirmed that the hydroxyapatite promotes the formation of bone around these artificial implants.

The second type of ceramic is an ideal supplement as a bone supplement which is absorbed by the body with time and is replaced by own bone in the body. The bone supplement which is replaced with the bone supplement itself or new bone is required for a mechanical strength in skeletal tissue such as a bone which is subjected to the mechanical load. In order to respond to this requirement, a hybrid material which can make a circumstance “scaffold”, which promotes cell proliferation and maintains the formation, is required.

Methods for bonding hydroxyapatite to bones, forming bones, and repairing damaged bones due to have been developed. For example, a method that involves the formation of a coating of a bone morphogenetic protein improves cellular adhesion, and also improves the subsequent bonding to tissue (for example, see Non-Patent Document 1). Moreover, another improvement method involves forming a nitride coating, thereby improving the hardness of the hydroxyapatite and improving the stability relative to biological environments (for example, see Non-Patent Document 2 and Non-Patent Document 3).

Further, Patent Document 1 discloses a combination of the formation of a nitride coating, and the application of a coating formed by DNA encoding of a bone morphogenetic protein or analog thereof.

Furthermore, it has also been reported that introducing a low-molecular weight poly(L-lactic acid) into the pores within a hydroxyapatite porous material via an enzymatic polymerization of L-lactide and lipase increases the mechanical strength of the hydroxyapatite material (for example, see Non-Patent Document 4 and Non-Patent Document 5).

### PRIOR ART DOCUMENTS

### Patent Documents

[Patent Document 1] U.S. Pat. No. 7,211,271

### Non-Patent Documents

[Non-Patent Document 1] Zeng, H., et al., Biomaterials, Volume 20 (1999): pp. 377 to 384.
[Non-Patent Document 2] Habelitz, S., et al., J. European Ceramic Society 19 (1999): pp. 2685 to 2694
[Non-Patent Document 3] Torrisi, L., Metallurgical Science and Technology 17(1) (1999): p. 2732.
[Non-Patent Document 4] Transactions of the 20^{th} Symposium of Apatite, pp. 28 to 29 (held: Dec. 17, 2007).
[Non-Patent Document 5] Preprints of the 21st Fall Meeting of The Ceramic Society of Japan, p. 8 (held: Sep. 17 to 19, 2008).

### SUMMARY OF THE INVENTION

### Problems to be Solved by the Invention

However, considering that 6 months are required for the generation of new bone tissue, when the β-tricalcium phosphate/poly(L-lactic acid) hybrid material disclosed in Non-Patent Document 5 is subjected to an in-vitro solubility test in a biological pseudo-body fluid environment, the poly(L-lactic acid) introduced into the β-tricalcium phosphate porous material dissolves and the three-point flexural strength deteriorates within the relatively short period of 28 days.

Moreover, in the above enzymatic polymerization, the L-lactide and lipase are introduced into the pores of the hydroxyapatite porous material, and must then be heated at 130° C. for 168 hours (7 days), meaning the preparation time is unreasonably long.

### Means to Solve the Problems

As a result of intensive research aimed at addressing the problems outlined above, the inventors of the present invention discovered that by employing a calcium phosphate/biodegradable polymer hybrid material prepared by complexing a calcium phosphate porous material and a biodegradable polymer having a average molecular weight of 50,000 to 500,000, the problems associated with the conventional technology could be resolved.

In other words, the present invention relates to the aspects [a] to [o] described below.

[a] A calcium phosphate/biodegradable polymer hybrid material prepared by complexing a calcium phosphate porous material and a biodegradable polymer having an average molecular weight of 50,000 to 500,000.

[b] The calcium phosphate/biodegradable polymer hybrid material according to [a], wherein the calcium phosphate porous material is a hydroxyapatite porous material.

[c] The calcium phosphate/biodegradable polymer hybrid material according to [a], wherein the calcium phosphate porous material is a β-tricalcium phosphate porous material.

[d] The calcium phosphate/biodegradable polymer hybrid material according to [a], wherein the average molecular weight of the biodegradable polymer is within a range from 50,000 to 300,000.

[e] The calcium phosphate/biodegradable polymer hybrid material according to [a], wherein the biodegradable polymer is at least one polymer selected from the group consisting of poly(L-lactic acid), poly(glycolic acid), poly(citric acid), L-lactic acid/glycolic acid copolymers, poly(ε-caprolactone), poly(β-hydroxybutyric acid) and chitosan.

[f] A method for producing a calcium phosphate/biodegradable polymer hybrid material prepared by complexing a calcium phosphate porous material and a biodegradable polymer, the method including immersing the calcium phosphate porous material within a solution containing a biodegradable polymer having an average molecular weight of 50,000 to 500,000, and performing an ultrasonic treatment or a suction treatment.

[g] The method according to [f], wherein the treatment is an ultrasonic treatment.

[h] The method according to [f] or [g], wherein following immersion in the solution containing the biodegradable polymer, the immersion liquid obtained as a result of the immersion treatment is subjected to 1 to 10 repetitions of the ultrasonic treatment.

[i] The method according to [f], wherein the suction treatment is performed by suctioning the solution containing the biodegradable polymer having an average molecular weight of 50,000 to 500,000 through the calcium phosphate porous material.

[j] The method according to [f], wherein the calcium phosphate/biodegradable polymer hybrid material is further subjected to a melt treatment and an annealing treatment, or to an annealing treatment.

[k] The method according to [f], wherein the calcium phosphate porous material is a hydroxyapatite porous material or a β-tricalcium phosphate porous material.

[l] The method according to [f], wherein the biodegradable polymer is at least one polymer selected from the group consisting of poly(L-lactic acid), poly(glycolic acid), poly(citric acid), L-lactic acid/glycolic acid copolymers, poly(s-caprolactone), poly(β-hydroxybutyric acid) and chitosan.

[m] The method according to [f], wherein the solvent for the solution containing the biodegradable polymer is chloroform.

[n] An implant including the calcium phosphate/biodegradable polymer hybrid material according to [a].

[o] The calcium phosphate/biodegradable polymer hybrid material according to [a], which is used as a scaffold.

### EFFECT OF THE INVENTION

The calcium phosphate/biodegradable polymer hybrid material of the present invention, prepared by complexing a calcium phosphate porous material and a biodegradable polymer having an average molecular weight of 50,000 to 500,000, exhibits enhanced strength. Further, by using a hydroxyapatite porous material or a β-tricalcium phosphate porous material as the calcium phosphate porous material, the strength is further increased, and the hybrid material can be used for reinforcing bone defects. Moreover, the hybrid material has highly interconnected fine pores, produces favorable proliferation of osteoblast-like cells, and can be used for press fitting. By using a β-tricalcium phosphate porous material as the calcium phosphate porous material, an additional effect is obtained in that the hybrid material also exhibits bioabsorbability and is gradually absorbed by the body.

### BRIEF DESCRIPTION OF THE DRAWINGS

FIG. 1 is an X-ray diffraction spectrum of a β-tricalcium phosphate porous material prepared in example 1.

FIG. 2 is a series of scanning electron microscope photographs (surface and cross-section) of the β-tricalcium phosphate porous material prepared in example 1.

FIG. 3 illustrates FT-IR spectra for the porous β-TCP prepared in example 1, β-tricalcium phosphate/poly(L-lactic acid) hybrid materials prepared in examples 2 and 3, and poly(L-lactic acid) (PLLA).

FIG. 4 is a graph illustrating the change in weight for the β-tricalcium phosphate/poly(L-lactic acid) hybrid materials prepared in examples 2, 3 and 4.

FIG. 5 is a graph illustrating the change in porosity for the β-tricalcium phosphate/poly(L-lactic acid) hybrid materials prepared in examples 2, 3 and 4, and the porous (β-TCP prepared in example 1.

FIG. 6 illustrates the results of elemental analysis by energy-dispersive X-ray spectroscopy of the β-tricalcium phosphate/poly(L-lactic acid) hybrid materials prepared in examples 2 and 3.

FIG. 7 illustrates the results of elemental analysis (point analysis) by energy-dispersive X-ray spectroscopy of the β-tricalcium phosphate/poly(L-lactic acid) hybrid materials prepared in example 2.

FIG. 8 illustrates the results of elemental analysis (point analysis) by energy-dispersive X-ray spectroscopy of the β-tricalcium phosphate/poly(L-lactic acid) hybrid materials prepared in example 3.

FIG. 9 illustrates three-point flexural strength values for the β-tricalcium phosphate/poly(L-lactic acid) hybrid materials prepared in examples 5 and 6.

FIG. 10 is a graph illustrating the proliferation of osteoblast-like cells (MC3T3-E1) on the porous β-TCP prepared in example 1, and the β-tricalcium phosphate/poly(L-lactic acid) hybrid materials prepared in examples 3 and 5.

### DETAILED DESCRIPTION OF THE INVENTION

Definitions of the terminology used in the description of the present invention are presented below.

In the present invention, a “calcium phosphate porous material” is prepared, for example, by the method disclosed by M. Aizawa et al. in “Fabrication of Porous Tricalcium Phosphate Ceramics from Calcium-phosphate Fibers for a Matrix of Biodegradable Ceramics/polymer Hybrids”, Phosphorus Res. Bull., 17, 209-210 (2004), and by Kawata et al. in “Development of porous ceramics with well-controlled porosities and pore sizes from apatite fibers and their evaluations”, Journal of Materials Sciences: Materials in medicine, Vol. 15, pp. 817-823 (2004). Specific examples of these materials include calcium phosphate porous materials with pores such as hydroxyapatite porous materials (HAp), β-tricalcium phosphate (β-TCP) porous materials, and α-tricalcium phosphate (α-TCP) porous materials.

In the present invention, the “biodegradable polymer” describes a polymer having an average molecular weight of 50,000 to 500,000, and preferably 50,000 to 300,000, which breaks down in vivo, such as poly(L-lactic acid), poly(glycolic acid), poly(citric acid), L-lactic acid/glycolic acid copolymers, poly(ε-caprolactone), poly(β-hydroxybutyric acid) and chitosan. If the average molecular weight is less than 50,000, formation of the hybrid material of the present invention is not able to produce the desired strength, whereas if the average molecular weight exceeds 500,000, then when used in the form of a solution, the viscosity tends to be too high, making the complexing treatment difficult. Any of these polymers may be used individually, or two or more polymers may be used as a mixture.

The three-point flexural strength of the hybrid material of the present invention is preferably 13 to 20 MPa and more preferably 14 to 18 MPa, when using β-TCP. When using HAp, it is preferably 5 to 15 MPa and more preferably 7 to 10 MPa.

Four methods for producing the calcium phosphate/biodegradable polymer hybrid material of the present invention are described below in detail, although the present invention is in no way limited to the methods described below.

[Production Method 1]

The production method 1 is composed of (1) a step of immersing a calcium phosphate porous material in a solution containing biodegradable polymer having an average molecular weight of 50,000 to 500,000, and (2) a step of subjecting the immersion liquid obtained in step (1) (hereinafter referred to as “immersion liquid”) to an ultrasonic treatment. The hybrid material of the present invention can be obtained by immersing the calcium phosphate porous material at room temperature in a solution containing the biodegradable polymer dissolved in, for example, a solvent such as acetone, chloroform or methylene chloride, subsequently subjecting the resulting immersion liquid to an ultrasonic treatment, for example using an ultrasonic cleaning device SUC-1L (manufactured by As One Corporation) at an oscillation frequency of 38 kHz, at room temperature and for a period of 5 minutes to 2 hours, and preferably 10 minutes to 1 hour, and then removing the ultrasonically treated material from the ultrasonic cleaning device and drying the material.

A compound having a surfactant action may be added to the solution containing the biodegradable polymer. Adding such a compound facilitates the penetration of the biodegradable polymer into the interior of the calcium phosphate porous material. Accordingly, isopropyl alcohol or the like may be added as an additive to the solvent described above.

[Production Method 2]

The production method 2 is composed of the same treatments as those described for [production method 1], with the exception that the step of subjecting the immersion liquid to an ultrasonic treatment is repeated a further 1 to 10 times. By using this production method, the amount of the polymer within the hybrid material of the present invention can be adjusted as required.

[Production Method 3]

The production method 3 involves suctioning a solution containing a biodegradable polymer having an average molecular weight of 50,000 to 500,000 through a calcium phosphate porous material. Specifically, a plate-like body of the calcium phosphate porous material is placed in a suction funnel that is connected to an aspirator via a cold trap of liquid nitrogen or the like, and then, at room temperature and under the suction of the aspirator, a solution of the biodegradable polymer dissolved in a solvent such as acetone, chloroform or methylene chloride is poured onto the porous material so as to completely cover the upper surface of the porous material. Following this suction treatment, the porous material is inverted, and once again positioned in the suction funnel. The solution containing the biodegradable polymer is then once again poured onto the upper surface of, and suctioned through, the porous material, which is then dried to complete preparation of a hybrid material of the present invention.

[Production Method 4]

The production method 4 is composed of a step of subjecting a calcium phosphate/biodegradable polymer hybrid material to a melt treatment and an annealing treatment, or to an annealing treatment. By subjecting the calcium phosphate/biodegradable polymer hybrid material obtained in any one of [production method 1] to [production method 3] to an annealing treatment, the crystallinity of the biodegradable polymer is improved and the strength of the hybrid material is increased, and by performing a melt treatment prior to the annealing treatment, the crystallinity of the biodegradable polymer can be further improved and the degradability reduced, which is ideal for application to the hybrid material of the present invention.

Next is a description of implantation.

[Implantation]

When using the calcium phosphate/biodegradable polymer hybrid material as an implant, an implant of the desired shape can be fabricated relatively easily by using a grinder or the like to grind a block of the calcium phosphate/biodegradable polymer hybrid material prepared using any one of [production method 1] to [production method 4] into the required shape.

### EXAMPLES

The present invention is described in more detail below, based on a series of examples. However, these examples are merely exemplary embodiments of the present invention, and in no way limit the scope of the invention.

### Example 1

750 mL of a test solution composed of 0.167 mol·dm⁻³ of Ca(NO₃)₂.4H₂O, 0.100 mol·dm⁻³ of (NH₄)₂PO₄, 0.500 mol·dm⁻³ of (NH₂)₂CO and 0.100 mol·dm⁻³ of HNO₃ (Ca/P=1.67) was heated at 80° C. for 48 hours. The solid in the resulting reaction liquid was filtered, washed, and then dried, yielding calcium phosphate fibers.

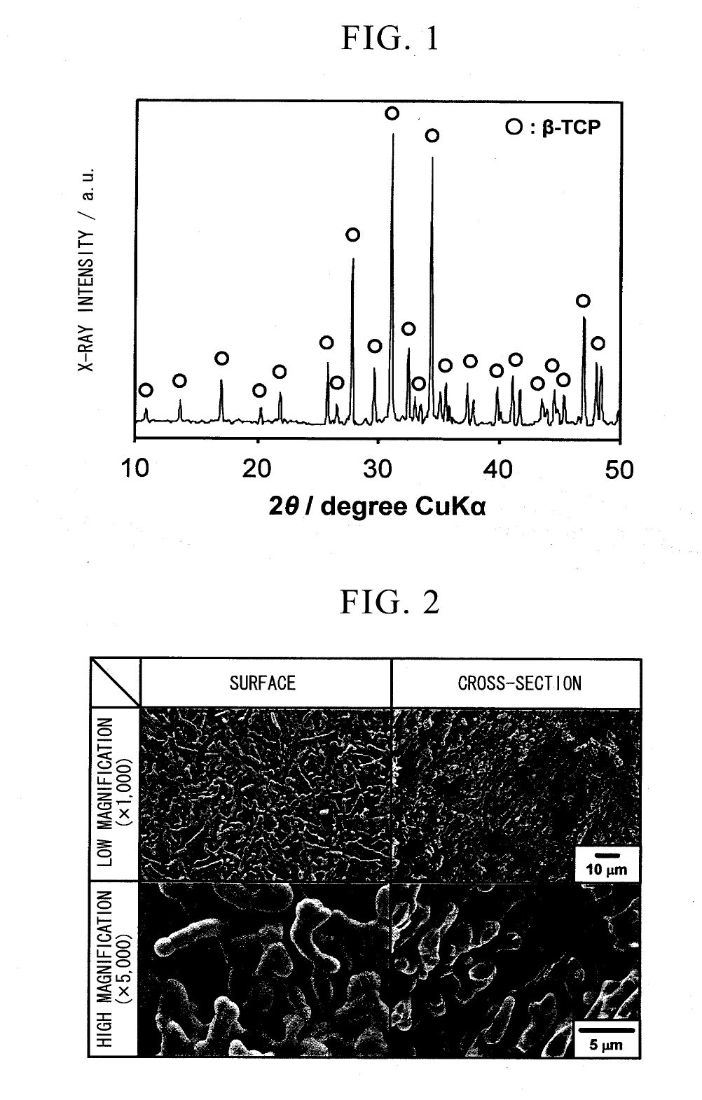

1 g of the thus obtained calcium phosphate fibers were subjected to uniaxial press molding (30 MPa), and the resulting compact was calcined for 5 hours in a box electric furnace at 1,000° C. (rate of temperature increase: 10° C./min), yielding a β-tricalcium phosphate porous material (porous β-TCP, porosity: approximately 54%) which exhibited the properties shown in the X-ray diffraction spectrum of FIG. 1, and had a shape illustrated in the surface and cross-sectional scanning electron microscope photographs of FIG. 2.

### Example 2

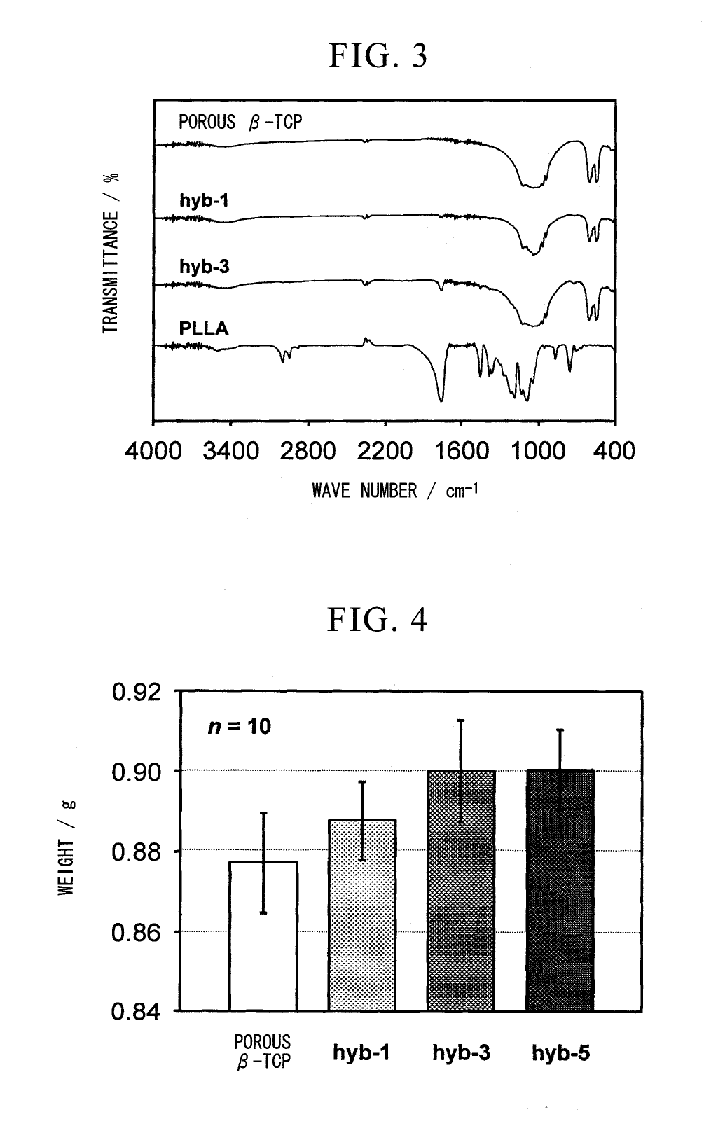

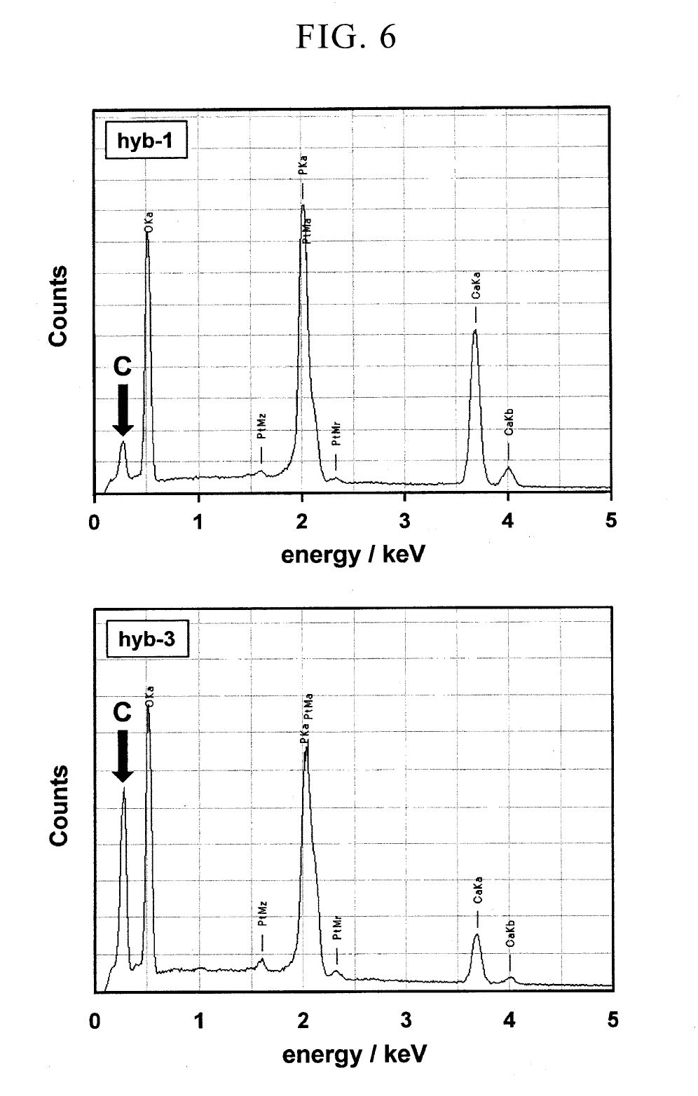

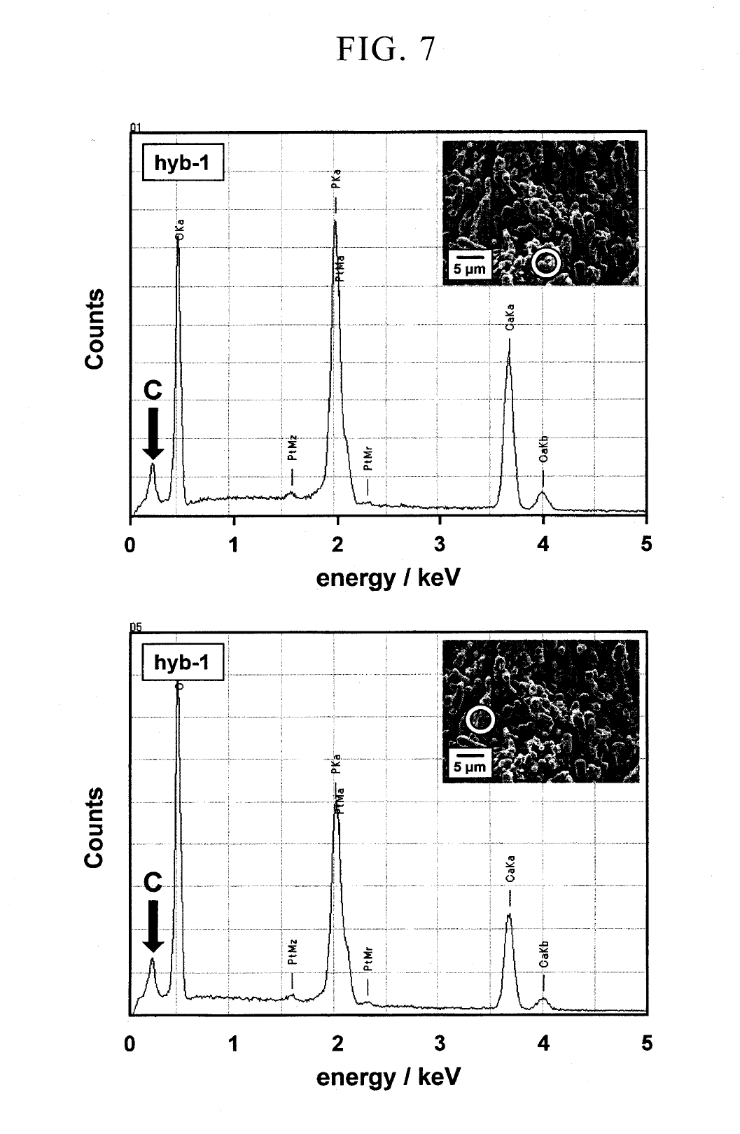

The β-tricalcium phosphate porous material obtained in example 1 was immersed in a 2% by mass chloroform solution of a poly(L-lactic acid) (RESOMER (a registered trademark) L210S, manufactured by Boehringer Ingelheim GmbH, average molecular weight: approximately 300,000), and the resulting immersion liquid was subjected to an ultrasonic treatment for 10 minutes in an ultrasonic cleaning device SUC-1L (manufactured by As One Corporation) (oscillation frequency: 38 kHz). The solid was then removed from the ultrasonically treated liquid and dried for 7 days at ambient pressure and ambient temperature, yielding a β-tricalcium phosphate/poly(L-lactic acid) hybrid material (hereinafter abbreviated as “hyb-1”) having the FT-IR spectrum, weight change, change in porosity, energy-dispersive X-ray spectroscopy spectrum, and energy-dispersive X-ray spectroscopy spectra (point analysis) illustrated in FIG. 3 to FIG. 7 respectively.

### Example 3

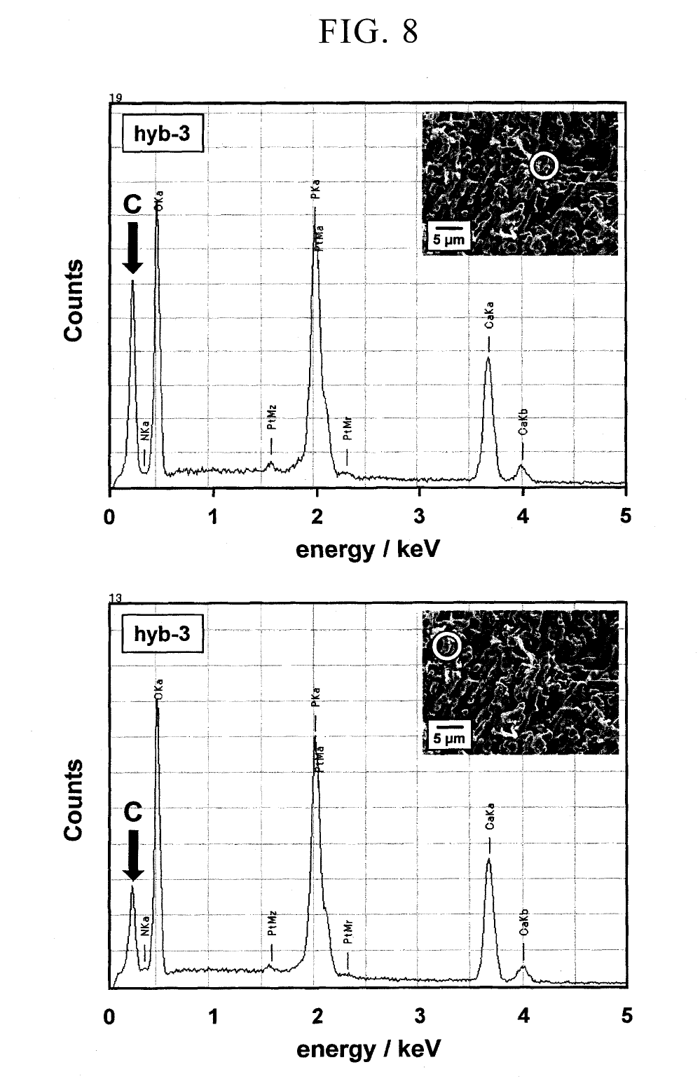

Using the β-tricalcium phosphate/poly(L-lactic acid) hybrid material obtained in example 2, the ultrasonic treatment performed in example 2 was repeated further 3 times. This yielded a tricalcium phosphate/poly(L-lactic acid) hybrid material (hereinafter abbreviated as “hyb-3”) having the FT-IR spectrum, weight change, change in porosity, energy-dispersive X-ray spectroscopy spectrum, and energy-dispersive X-ray spectroscopy spectra (point analysis) illustrated in FIG. 3 to FIG. 6 and FIG. 8 respectively.

### Example 4

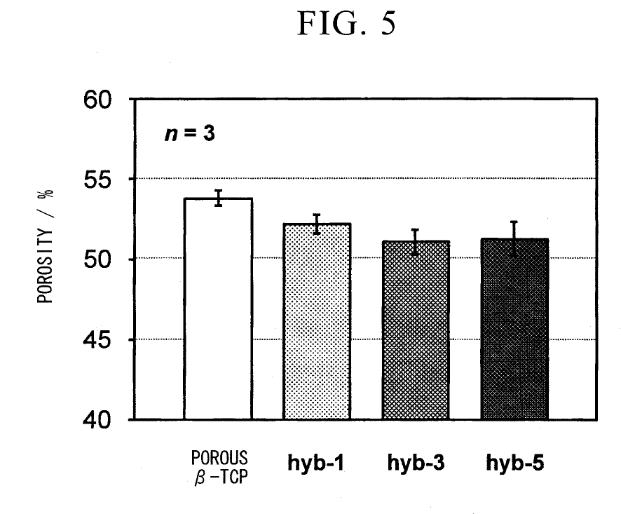

Using the β-tricalcium phosphate/poly(L-lactic acid) hybrid material obtained in example 2, the ultrasonic treatment performed in example 2 was repeated further 5 times. This yielded a tricalcium phosphate/poly(L-lactic acid) hybrid material (hereinafter abbreviated as “hyb-5”) that exhibited the weight change and change in porosity illustrated in FIG. 4 and FIG. 5 respectively.

### Example 5

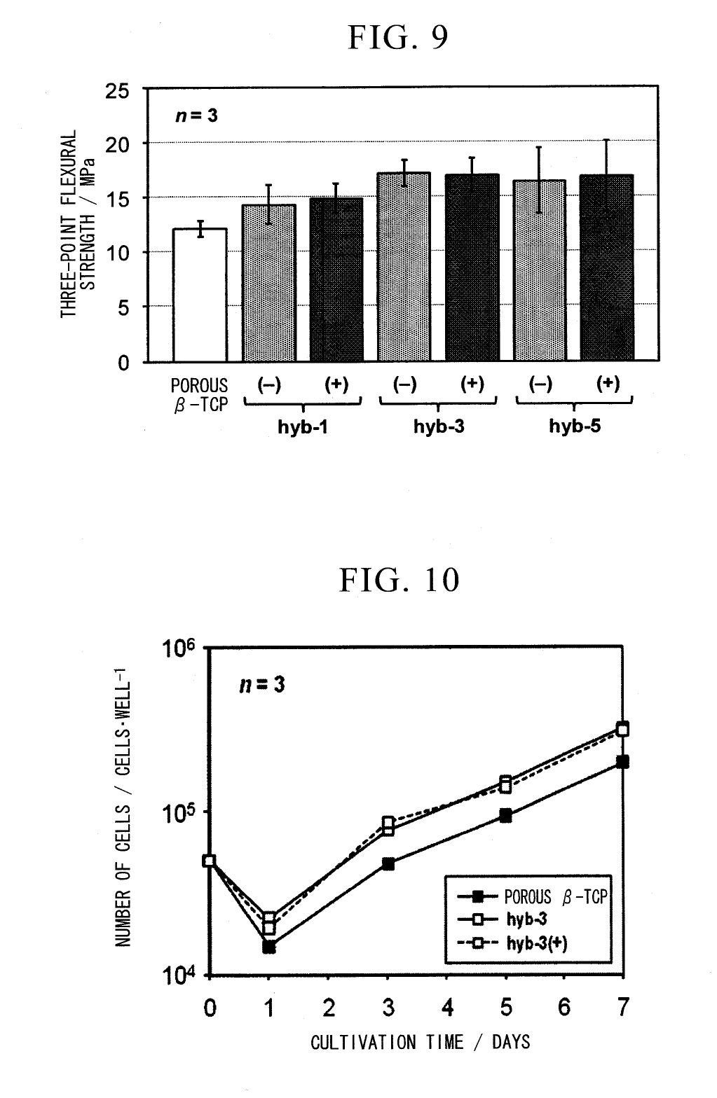

Each of the three β-tricalcium phosphate/poly(L-lactic acid) hybrid materials obtained in example 2, example 3 and example 4 (namely, hyb-1, hyb-3 and hyb-5) was heated for 30 minutes at 200° C. (a melt treatment). Subsequently, the resulting β-tricalcium phosphate/poly(L-lactic acid) hybrid materials were cooled, and then heated at 140° C. for 24 hours (an annealing treatment), yielding β-tricalcium phosphate/poly(L-lactic acid) hybrid materials (hyb-1(+), hyb-3(+) and hyb-5(+)) which, as illustrated in FIG. 9, exhibited improved three-point flexural strength, measured in accordance with the Japan Industrial Standard (JIS R 1601), compared with the β-tricalcium phosphate porous material (porous β-TCP).

### Example 6

The three β-tricalcium phosphate/poly(L-lactic acid) hybrid materials obtained in example 2, example 3 and example 4 (namely, hyb-1, hyb-3 and hyb-5) were each heated at 140° C. for 24 hours (an annealing treatment), yielding β-tricalcium phosphate/poly(L-lactic acid) hybrid materials (hyb-1(−), hyb-3(−) and hyb-5(−)) which, as illustrated in FIG. 9, exhibited improved three-point flexural strength compared with the β-tricalcium phosphate porous material (porous (β-TCP).

### Example 7

A β-tricalcium phosphate/poly(L-lactic acid) hybrid material of the present invention was evaluated for its cell proliferation properties relative to osteoblast-like cells. Namely, 5×10⁴ osteoblast-like cells (MC3T3-E1) within a culture medium composed of α-MEM (manufactured by Gibco) containing 10% bovine fetal serum were seeded onto a pellet-like test piece (15 mmΦ×2 mm), the cells were cultured within the above medium, and the number of cells was then counted. The results are shown in FIG. 10. As the test pieces, the β-tricalcium phosphate porous material prepared in example 1, and the β-tricalcium phosphate/poly(L-lactic acid) hybrid materials hyb-3 and hyb-3(+) were used.

As is evident from FIG. 10, the β-tricalcium phosphate/poly(L-lactic acid) hybrid materials of the present invention (hyb-3 and hyb-3(+)) exhibited a level of proliferation of the osteoblast-like cells that was superior to that observed for the β-tricalcium phosphate porous material (porous β-TCP).

### Example 8

750 mL of a test solution composed of 0.167 mol·dm⁻³ of Ca(NO₃)₂.4H₂O, 0.100 mol·dm⁻³ of (NH₄)₂PO₄, 0.500 mol·dm³ of (NH₂)₂CO and 0.100 mol·dm⁻³ of HNO₃ (Ca/P=1.67) was heated at 80° C. for 24 hours, and then at 90° C. for 72 hours. The resulting product was filtered, washed, and then dried, yielding hydroxyapatite fibers.

1 g of carbon beads were mixed with 1 g of the thus obtained hydroxyapatite fibers, the resulting mixture was subjected to uniaxial press molding (40 MPa), and the resulting compact was calcined for 5 hours in a tubular furnace under a steam atmosphere at 1,300° C. (rate of temperature increase: 5° C./min), yielding a hydroxyapatite porous material (porosity: approximately 70%).

### Example 9

The hydroxyapatite porous material obtained in example 8 was immersed in a 3% by mass chloroform solution of a poly(L-lactic acid) (RESOMER (a registered trademark) L207S, manufactured by Boehringer Ingelheim GmbH, average molecular weight: approximately 100,000), and an ultrasonic treatment was performed for 10 minutes. Following the ultrasonic treatment, the solid was removed from the liquid and dried for 50 minutes at room temperature (25° C.±3° C.), yielding a hydroxyapatite/poly(L-lactic acid) hybrid material.

The above steps were then repeated further 4 times to prepare a hydroxyapatite/poly(L-lactic acid) hybrid material.

### Example 10

With the exception of using a 5% by mass chloroform solution of RESOMER (a registered trademark) L207S (manufactured by Boehringer Ingelheim GmbH, average molecular weight: approximately 100,000) as the poly(L-lactic acid) solution, treatment was performed in the same manner as example 9, yielding a hydroxyapatite/poly(L-lactic acid) hybrid material.

### Example 11

With the exception of using a 3% by mass chloroform solution of RESOMER (a registered trademark) L210S (manufactured by Boehringer Ingelheim GmbH, average molecular weight: approximately 300,000) as the poly(L-lactic acid) solution, treatment was performed in the same manner as example 9, yielding a hydroxyapatite/poly(L-lactic acid) hybrid material.

### Example 12

The hydroxyapatite/poly(L-lactic acid) hybrid materials obtained in example 9, example 10 and example 11 were each subjected to a three-point flexural strength measurement in accordance with the Japan Industrial Standard (JIS R 1601). The results are listed below in Table-1.

From the results in Table-1 it is evident that the hydroxyapatite/poly(L-lactic acid) hybrid materials obtained in example 9, example 10 and example 11 exhibited three-point flexural strength values that were superior to that of the hydroxyapatite porous material obtained in example 8.

TABLE 1

| Hydroxyapatite/poly(L-lactic acid) | Three-point flexural |
|---|---|
| hybrid material | strength (MPa) |
| Example 9 | 8.91 |
| Example 10 | 9.48 |
| Example 11 | 7.02 |
| Hydroxyapatite porous material | 4.93 |
| obtained in example 8 | |

### Example 13

A circular disc-shaped hydroxyapatite porous material (diameter: approximately 16 mm×thickness: approximately 2.3 mm, porosity: approximately 70%) was immersed in a 2% by mass chloroform solution of a poly(L-lactic acid) (RESOMER (a registered trademark) L207S, manufactured by Boehringer Ingelheim GmbH, average molecular weight: approximately 100,000), and the resulting immersion liquid was subjected to an ultrasonic treatment for 10 minutes in an ultrasonic cleaning device SUC-1L (oscillation frequency: 38 kHz). The solid was then dried for 50 minutes at room temperature (25° C.±3° C.), yielding a hydroxyapatite/poly(L-lactic acid) hybrid material.

### Example 14

Using the hydroxyapatite/poly(L-lactic acid) hybrid material obtained in example 13, the ultrasonic treatment performed in example 13 was repeated further 2 times, yielding a hydroxyapatite/poly(L-lactic acid) hybrid material.

### Example 15

Using the hydroxyapatite/poly(L-lactic acid) hybrid material obtained in example 13, the ultrasonic treatment performed in example 13 was repeated further 4 times, yielding a hydroxyapatite/poly(L-lactic acid) hybrid material.

### Example 16

The upper and lower surfaces of a circular disc-shaped hydroxyapatite porous material (porosity: 70%) (hereinafter referred to as “the test piece”) were polished, and the side surfaces of the test piece were then coated 5 times with a 3% by mass chloroform solution of a poly(L-lactic acid) (RESOMER (a registered trademark) L210S, manufactured by Boehringer Ingelheim GmbH, average molecular weight: approximately 300,000), yielding a test piece [a]. The coated test piece was then placed in a suction funnel that was connected to an aspirator provided with a cold trap of liquid nitrogen. Subsequently, under suction from the aspirator (suction power: 3.3 to 10.8 L/min), an operation in which a 2% by mass chloroform solution of a poly(L-lactic acid) (RESOMER (a registered trademark) L2075, manufactured by Boehringer Ingelheim GmbH, average molecular weight: approximately 100,000) was dripped onto the test piece at such a rate that the entire upper surface of the test piece was temporarily covered by the solution was repeated 9 times. The resulting test piece was then inverted and repositioned in the suction funnel, and the above operation of dripping the 2% by mass chloroform solution of a poly(L-lactic acid) (RESOMER (a registered trademark) L207S, manufactured by Boehringer Ingelheim GmbH, average molecular weight: approximately 100,000) onto the test piece under suction was performed 3 times. The test piece was then inverted again, subjected to the above dripping operation further 8 times, once again inverted, subjected to the dripping operation further 2 times, and then inverted once again, and subjected to the dripping operation further 8 times (total number of dripping operations: 30, time required: approximately 1.5 hours). The thus obtained hydroxyapatite porous material was dried (at room temperature (25° C.±3° C.) for 50 minutes), yielding a hybrid composed of a complex of the hydroxyapatite and the poly(L-lactic acid) (test piece [b]). The changes in the weight of the test piece upon completing the above treatments and drying are listed below in Table-2. From the results in this table it is clear that the poly(L-lactic acid) has complexed with the disc-shaped hydroxyapatite porous material.

TABLE 2

| Sample | Weight (g) |
|---|---|
| Test piece | 0.3895 |
| Test piece following polishing of | 0.3439 |
| upper and lower surfaces | |
| Test piece [a] following coating of | 0.3644 |
| side surfaces | |
| Test piece [b] following complexing of | 0.4491 |
| poly(L-lactic acid) | |
| Weight of complexed poly(L-lactic acid) | 0.0847 |
| ([b] − [a]) | |

### Example 17

Distilled water was added to 5 g of calcium phosphate fibers (hereinafter abbreviated as CPF) that had been synthesized using a uniform precipitation method, thus preparing 250 g of a 2% by mass CPF slurry. Separate samples of this CPF slurry were mixed with a predetermined amount of carbon beads having an average particle size of 150 μm (hereinafter abbreviated as CB), the amount being equivalent to 100, 75, 50, 25 or 0% by mass of the slurry, together with 105 g of an ethanol aqueous solution having a water: ethanol volumetric ratio of 7:3, and an amount of agar equivalent to 0.1% of the total weight of the CPF slurry, and the resulting mixture was then heated at approximately 90° C. to melt the agar. The resulting mixture was subjected to suction filtration using an acrylic resin mold to prepare a preform, and this preform was then subjected to uniaxial press molding at 40 MPa to form a compact. This compact was calcined under an air flow in a tubular furnace at 1,000° C. for 5 hours, yielding a β-tricalcium phosphate porous material (porous β-TCP) having a combination of macropores and micropores. In this example, the porosity of the porous material was able to be controlled within a range from 50% to 85% in accordance with the CB amount.

In this manner, during the preparation of the β-tricalcium phosphate porous material, by adding particles that can be eliminated by subsequent firing at high temperature, a compact of the porous material having the desired porosity, specific surface area and pore size can be prepared with relative ease, and the addition of CB or the like is particularly effective for this purpose.

### INDUSTRIAL APPLICABILITY

The calcium phosphate/biodegradable polymer hybrid material of the present invention has highly interconnected fine pores and enhanced strength, and can be used for reinforcing bone defects. Moreover, because the hybrid material also produces favorable proliferation of osteoblast-like cells and can be used for press fitting into bone defects, it can also be used as an implant material.

What is claimed is:

1. A calcium phosphate/biodegradable polymer hybrid material prepared by complexing a calcium phosphate porous material and a biodegradable polymer having an average molecular weight of 50,000 to 500,000.

2. The calcium phosphate/biodegradable polymer hybrid material according to claim 1, wherein the calcium phosphate porous material is a hydroxyapatite porous material.

3. The calcium phosphate/biodegradable polymer hybrid material according to claim 1, wherein the calcium phosphate porous material is a 13-tricalcium phosphate porous material.

4. The calcium phosphate/biodegradable polymer hybrid material according to claim 1, wherein an average molecular weight of the biodegradable polymer is within a range from 50,000 to 300,000.

5. The calcium phosphate/biodegradable polymer hybrid material according to claim 1, wherein the biodegradable polymer is at least one polymer selected from the group consisting of poly(L-lactic acid), poly(glycolic acid), poly(citric acid), L-lactic acid/glycolic acid copolymers, poly(s-caprolactone), poly(β-hydroxybutyric acid) and chitosan.

6. A method for producing a calcium phosphate/biodegradable polymer hybrid material prepared by complexing a calcium phosphate porous material and a biodegradable polymer, the method comprising immersing the calcium phosphate porous material within a solution comprising a biodegradable polymer having an average molecular weight of 50,000 to 500,000, and performing an ultrasonic treatment or a suction treatment.

7. The method according to claim 6, wherein the treatment is an ultrasonic treatment.

8. The method according to claim 6, wherein following immersion in the solution comprising the biodegradable polymer, an immersion liquid obtained as a result of the immersion is subjected to 1 to 10 repetitions of an ultrasonic treatment.

9. The method according to claim 6, wherein the suction treatment is performed by suctioning the solution comprising the biodegradable polymer having an average molecular weight of 50,000 to 500,000 through the calcium phosphate porous material.

10. The method according to claim 6, wherein the calcium phosphate/biodegradable polymer hybrid material is further subjected to a melt treatment and an annealing treatment, or to an annealing treatment.

11. The method according to claim 6, wherein the calcium phosphate porous material is a hydroxyapatite porous material or a β-tricalcium phosphate porous material.

12. The method according to claim 6, wherein the biodegradable polymer is at least one polymer selected from the group consisting of poly(L-lactic acid), poly(glycolic acid), poly(citric acid), L-lactic acid/glycolic acid copolymers, poly(ε-caprolactone), poly(β-hydroxybutyric acid) and chitosan.

13. The method according to claim 6, wherein a solvent for the solution comprising the biodegradable polymer is chloroform.

14. An implant comprising the calcium phosphate/biodegradable polymer hybrid material according to claim 1.

15. The calcium phosphate/biodegradable polymer hybrid material according to claim 1, which is used as a scaffold.
